(19) United States
(12) Patent Application Publication
(10) Pub. No.: US 2008/0123621 A1
(43) Pub. Date: May 29, 2008

(54) High speed access broadcast system solution

(76) Inventor: Alexander Bachmutsky, Sunnyvale, CA (US)

Correspondence Address: SQUIRE, SANDERS & DEMPSEY L.L.P., 8000 TOWERS CRESCENT, 14TH FLOOR, TYSONS CORNER, VA, 22182-2700, US

(21) Appl. No.: 11/605,363

(22) Filed: Nov. 29, 2006

(51) Int. Cl. H04L 12/28

(52) U.S. Cl. 370/351

(57) ABSTRACT

A network element provides broadcast/multicast support. The network element is configured to be operably connected with at least one stream source and with a terminal. The network element is further configured to process a multicast stream over a logical connection which has been dedicated between the stream source and the network element as one of a plurality of network elements participating in the logical connection. In addition, the network element is configured to map the logical connection into a broadcast/multicast radio channel which corresponds to the operable connection to the terminal.

### FIELD OF THE INVENTION

The present invention relates to a network element, a system and a method for providing high speed broadcast access.

### BACKGROUND OF THE INVENTION

Multicast and broadcast services are becoming very important applications for broadband wireless services. There are some services for multimedia delivery in GPRS (general packet radio system) and WCDMA (wide-band code division multiple access) networks, specially designed DVB-H (digital video broadcasting-handheld) networks and more. The existing solutions are very generic and trying to cover all aspects of multicast and broadcast services. The same direction is taken in the standards definitions for new mobile networks such as worldwide interoperability for microwave access (WiMAX), long term evolution (LTE) upgrade path for 3^{rd} generation (3G) systems of the 3GPP (3rg generation partnership project), etc. These solutions are usually complex to define, implement and deploy.

However, there is a need for a much simpler solution that can allow operators getting revenue from multimedia streaming in near term.

### SUMMARY OF THE PRESENT INVENTION

Thus, it is an object of the present invention to overcome the shortcomings of the prior art.

In particular, the present invention aims at providing multicast/broadcast support for WiMAX technology.

According to a first aspect of the present invention, there is provided a network element for providing broadcast/multicast support which is configured to be operably connected with at least one stream source; be operably connected with a terminal; process a multicast stream over a logical connection which has been dedicated between the stream source and the network element as one of a plurality of network elements participating in the logical connection; and map the logical connection into a broadcast/multicast radio channel which corresponds to the operable connection to the terminal.

Modifications of the first aspect can include the following.

The network element may be further configured to be a base station according to the worldwide interoperability for microwave access (WiMAX) certificate.

The network element can be further configured not to transmit anything to the broadcast/multicast radio channel, if there is no actual operable connection to a terminal present on that channel.

The logical connection may correspond to a virtual local area network.

The logical connection may correspond to a physical connection.

According to a second aspect of the present invention, there is provided a system for providing broadcast/multicast support, comprising at least one stream source configured to provide a multicast stream; a switch operably connected with each of the plurality of stream sources; at least one base station operably connected with the switch; and at least one terminal operably connected with one of the plurality of base stations, wherein the system is configured to send a multicast stream over a dedicated logical connection between a stream source of the multicast stream and selected ones of the plurality of base stations which are selected to be comprised in a respective logical connection, and map the logical connection into a broadcast/multicast radio channel which corresponds to the operable connection between a terminal operated to receive the multicast stream and its respective base station.

Modifications of the second aspect can include the following.

The system may further comprise a base transceiver unit including the plurality of base stations, a transport unit and an internal switch, wherein each of the plurality of base stations is operably connected with the internal switch, the internal switch is operably connected with the transport unit, and the transport unit is operably connected with the switch.

The system may be further configured to be operated according to the worldwide interoperability for microwave access (WiMAX) certificate.

The logical connection may correspond to a virtual local area network.

The logical connection may correspond to a physical connection.

According to a third aspect of the present invention, there is provided a method of providing support for broadcast/multicast support, comprising sending a multicast stream over a dedicated logical connection between a stream source of the multicast stream and selected ones of a plurality of base stations which are selected to be comprised in a respective logical connection, and mapping the logical connection into a broadcast/multicast radio channel which corresponds to an operable connection between a terminal operated to receive the multicast stream and a respective base station.

Modifications of the third aspect may include the following.

The base station may be comprised in a base transceiver unit, and the method may further comprise sending the multicast stream over the dedicated logical connection between a stream source of the multicast stream and selected ones of a plurality of base stations which are selected to be comprised in a respective logical connection, wherein the dedicated connection also involves a transport unit comprised in the base transceiver unit and an internal switch comprised in the base transceiver unit.

The logical connection may correspond to a virtual local area network.

The logical connection may correspond to a physical connection.

According to a fourth aspect of the present invention, there is provided a network element for providing broadcast/multicast support, comprising connecting means for an operable connection with at least one stream source; connecting means for an operable connection with a terminal; processing means for processing a multicast stream over a logical connection which has been dedicated between the stream source and the network element as one of a plurality of network elements participating in the logical connection; and mapping means for mapping the logical connection into a broadcast/multicast radio channel which corresponds to the operable connection to the terminal.

According to a fifth aspect of the present invention, there is provided a system for providing broadcast/multicast support, comprising at least one stream source means configured to provide a multicast stream; switching means operably connected with each of the plurality of stream source means; at least one base station means operably connected with the switching means; and at least one terminal means operably connected with one of the plurality of base station means, wherein the system is configured to send a multicast stream over a dedicated logical connection between a stream source means of the multicast stream and selected ones of the plurality of base station means which are selected to be comprised in a respective logical connection, and map the logical connection into a broadcast/multicast radio channel which corresponds to the operable connection between a terminal means operated to receive the multicast stream and its respective base station means.

According to a sixth aspect of the present invention, there is provided a computer program product having computer readable instructions stored thereon, the instructions including sending a multicast stream over a dedicated logical connection between a stream source of the multicast stream and selected ones of a plurality of base stations which are selected to be comprised in a respective logical connection, and mapping the logical connection into a broadcast/multicast radio channel which corresponds to an operable connection between a terminal operated to receive the multicast stream and a respective base station.

### BRIEF DESCRIPTION OF THE DRAWINGS

Further details, features and advantages of the present invention may become more readily understandable from the following description of its preferred embodiments which is to be taken in conjunction with the appended drawings, in which:

FIG. 1 shows network architecture for simple broadcast services with base stations according to an embodiment of the present invention;

FIG. 2 shows a data flow between a broadcast/multicast stream source and corresponding radio broadcast/multicast channels visualizing another embodiment of the present invention; and

FIG. 3 shows network architecture for simple broadcast services with a base transceiver system according to still another embodiment of the present invention.

### DESCRIPTION OF THE PREFERRED EMBODIMENTS

In the following, a description is presented of what are presently considered to be preferred embodiments of the present invention. It is, however, to be expressly understood that the present invention is not to be construed as being limited to the described embodiments.

With embodiments of the present invention described hereinafter, the application of simple broadcast streaming is considered (while at least from transport point of view, it could be multicast in means of IP addressing). According to one embodiment of the present invention, an end-user just selects the required broadcast service similar to TV channel selection. The assumption here is that next generation broadband networks will support some kind of broadcast service at the radio level instead of sending a stream to every subscriber.

Potential use cases include streaming for special events (stadium, exhibition, show, etc.) as well as location-dependent advertisement. In the first case (special events), the revenue is based on either special equipment rent or one-time subscription (to prevent unauthorized use of the service, the stream could be encrypted). In the second case, the revenue comes from advertisers and therefore it is unprotected and can run on any terminals supporting broadcast/multicast radio service.

It is also important to emphasize that in many areas where special events are taking place there is no significant limitation in throughput capacity between a central site and base station(s). For example, as a simple and cheap solution, some kind of Ethernet connections could be deployed.

As discussed above, the existing solutions for multicast/broadcast services are too generic and too complex. Thus, there is a need for a simple solution using standard IP TV-like equipment to deliver broadcast streaming to mobile terminals.

According to a preferred embodiment of the present invention, the existing high-speed L2 (layer 2) infrastructure between base stations and central site(s) is used.

Specifically, every multicast/broadcast stream is sent over a dedicated logical connection such as a tunnel, a multiprotocol label switching (MPLS), an asynchronous transfer mode (ATM) virtual circuit (VC) or a virtual local area network (VLAN) connection between the source of the stream and all participating base stations. A respective base station maps the logical connection into the corresponding broadcast/multicast radio channel.

In the following, the preferred embodiments of the present invention are described by taking a virtual local area network as an example of a logical connection.

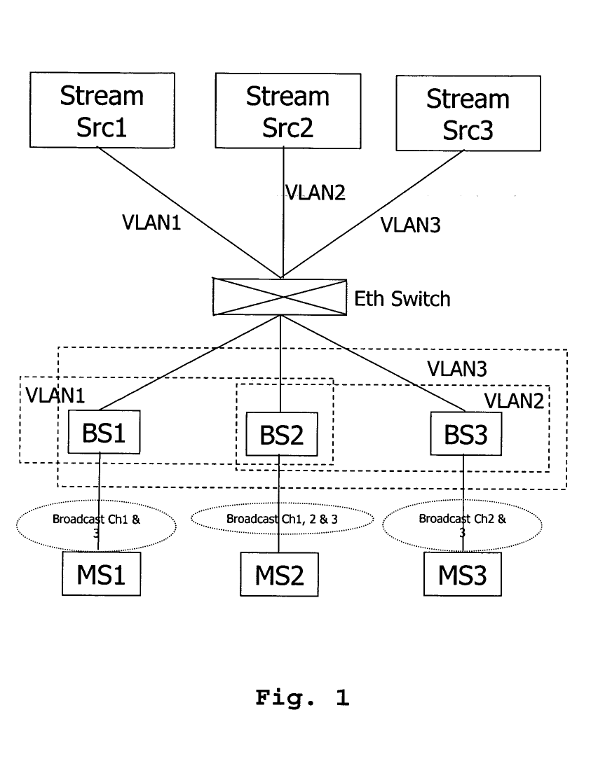

An example of a network diagram for the present embodiment is shown in FIG. 1.

As illustrated therein, every stream source (Src1, Src2, Src3) is using its own logical port (with VLAN shown in FIG. 1 and used in the following as an example), which can also be a separate physical port.

An Ethernet switch is configured to deliver all multicast/broadcast data coming for VLAN1 to virtual local area networks (or ports) toward the base stations BS1 and BS2; all multicast/broadcast data coming for VLAN2 to virtual local area networks (or ports) toward base stations BS2 and BS3; and all multicast/broadcast data coming for VLAN3 to virtual local area networks (or ports) toward all three base stations. Each base station maps the incoming VLAN to its corresponding broadcast/multicast channel (shown as broadcast channels Ch1, Ch2 and CH3).

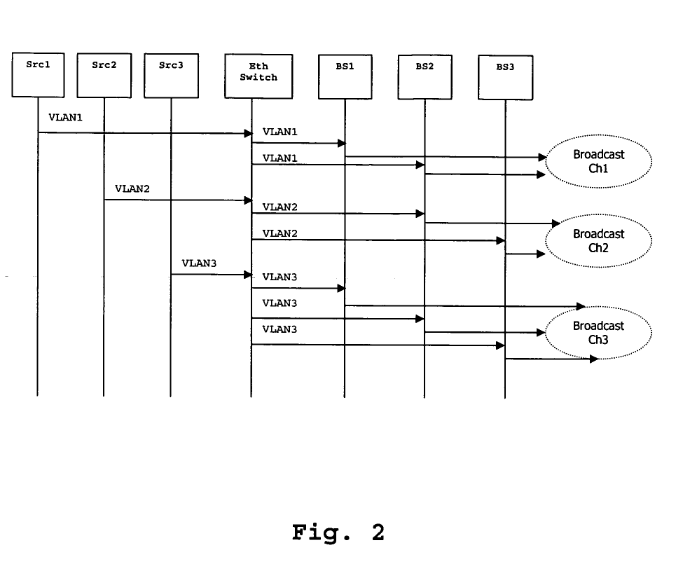

FIG. 2 shows a method corresponding to the system shown in FIG. 1 as a data flow between respective broadcast/multicast stream sources and corresponding radio broadcast/multicast channels as another embodiment of the present invention. However, the description provided above with respect to FIG. 1 also applies here, and its repetition is omitted for conciseness.

In FIG. 2, terminals are not shown, because they are capable to watch any channel transmitted in the air. If the channel is encrypted, the terminal will be able to watch it only if the channel was paid for and as a result encryption was explicitly provisioned in the terminal.

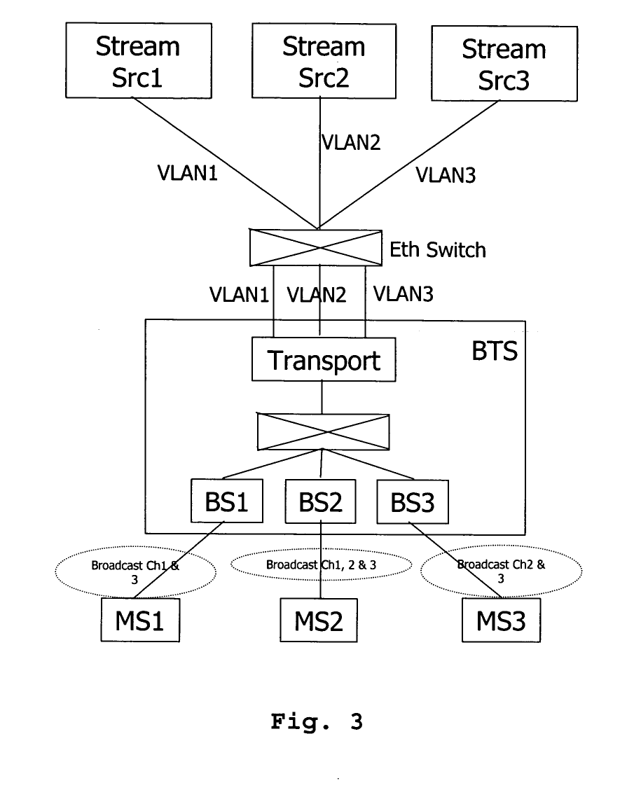

Some base station implementations combine multiple separate base stations in a single physical network element (which sometimes is called base transceiver station BTS). If such implementations comprises some common transport element, e.g. in OBSAI architecture (open base station architecture initiative), and/or internal Ethernet switch, the embodiment described above in connection with FIG. 1 might be even more optimized according to FIG. 3.

The difference between FIG. 3 and FIG. 1 is that in FIG. 3 an external Ethernet switch is configured to deliver data to a base transceiver system (BTS) (of which only one is shown for simplicity) instead of to separate base stations, thus preserving in some cases bandwidth between the Ethernet switch and the BTS, e.g. when not all services need to come to all base stations of that BTS. In such a configuration, the transport element of the BTS and/or its internal switch could be configured with additional policies for mapping between virtual local area networks and internal base stations/radio channels.

In any one of the above described embodiments, a further modification could be that the base stations and/or the base transceiver system could be implemented with an intelligence not to transmit anything to the broadcast/multicast channel, if there are no terminals listening on that channel. This may require explicit signaling between this terminal such as a mobile station MS and a base station BS to establish a radio bearer for multicast/broadcast or subscribe to the selected service channel. In addition, the implementation of such a solution may be dependent on the type of wireless network.

The above described embodiments of the present invention present a solution which is easy to implement and without the need for multicast IP signaling.

A potential implementation of the above described embodiments is seen in WiMAX deployments.

Specifically, the above described preferred embodiments of the present invention include a network element which provides broadcast/multicast support. The network element is configured to be operably connected with at least one stream source and with a terminal. The network element is further configured to process a multicast stream over a logical connection which has been dedicated between the stream source and the network element as one of a plurality of network elements participating in the logical connection. In addition, the network element is configured to map the logical connection into a broadcast/multicast radio channel which corresponds to the operable connection to the terminal.

What has been described above is what are presently considered to be preferred embodiments of the present invention. However, as is apparent to the skilled reader, these are provided for illustrative purposes only and are in no way intended to be construed that the present invention is restricted thereto. Rather, it is the intention that all variations and modifications be included which fall within the spirit and scope of the appended claims.

1. A network element for providing broadcast/multicast support which is configured to
be operably connected with at least one stream source;
be operably connected with a terminal;
process a multicast stream over a logical connection which has been dedicated between the stream source and the network element as one of a plurality of network elements participating in the logical connection; and
map the logical connection into a broadcast/multicast radio channel which corresponds to the operable connection to the terminal.

2. The network element according to claim 1, further configured to be a base station according to the worldwide interoperability for microwave access (WiMAX) certificate.

3. The network element according to claim 1, further configured not to transmit anything to the broadcast/multicast radio channel, if there is no actual operable connection to a terminal present on that channel.

4. The network element according to claim 1, wherein the logical connection corresponds to a virtual local area network.

5. The network element according to claim 1, wherein the logical connection corresponds to a physical connection.

6. A system for providing broadcast/multicast support, comprising
at least one stream source configured to provide a multicast stream;
a switch operably connected with each of the plurality of stream sources;
at least one base station operably connected with the switch; and
at least one terminal operably connected with one of the plurality of base stations,
wherein the system is configured to
send a multicast stream over a dedicated logical connection between a stream source of the multicast stream and selected ones of the plurality of base stations which are selected to be comprised in a respective logical connection, and
map the logical connection into a broadcast/multicast radio channel which corresponds to the operable connection between a terminal operated to receive the multicast stream and its respective base station.

7. The system according to claim 6, further comprising a base transceiver unit including the plurality of base stations, a transport unit and an internal switch, wherein each of the plurality of base stations is operably connected with the internal switch, the internal switch is operably connected with the transport unit, and the transport unit is operably connected with the switch.

8. The system according to claim 6, further configured to be operated according to the worldwide interoperability for microwave access (WiMAX) certificate.

9. The system according to claim 6, wherein the logical connection corresponds to a virtual local area network.

10. The system according to claim 6, wherein the logical connection corresponds to a physical connection.

11. A method of providing support for broadcast/multicast support, comprising:
sending a multicast stream over a dedicated logical connection between a stream source of the multicast stream and selected ones of a plurality of base stations which are selected to be comprised in a respective logical connection, and
mapping the logical connection into a broadcast/multicast radio channel which corresponds to an operable connection between a terminal operated to receive the multicast stream and a respective base station.

12. The method according to claim 11, wherein the base station is comprised in a base transceiver unit, further comprising
sending the multicast stream over the dedicated logical connection between a stream source of the multicast stream and selected ones of a plurality of base stations which are selected to be comprised in a respective logical connection, wherein the dedicated connection also involves a transport unit comprised in the base transceiver unit and an internal switch comprised in the base transceiver unit.

13. The method according to claim 11, wherein the logical connection corresponds to a virtual local area network.

14. The method according to claim 11, wherein the logical connection corresponds to a physical connection.

15. A network element for providing broadcast/multicast support, comprising
connecting means for an operable connection with at least one stream source;
connecting means for an operable connection with a terminal;
processing means for processing a multicast stream over a logical connection which has been dedicated between the stream source and the network element as one of a plurality of network elements participating in the logical connection; and
mapping means for mapping the logical connection into a broadcast/multicast radio channel which corresponds to the operable connection to the terminal.

16. A system for providing broadcast/multicast support, comprising
at least one stream source means configured to provide a multicast stream;
switching means operably connected with each of the plurality of stream source means;
at least one base station means operably connected with the switching means; and
at least one terminal means operably connected with one of the plurality of base station means,
wherein the system is configured to
send a multicast stream over a dedicated logical connection between a stream source means of the multicast stream and selected ones of the plurality of base station means which are selected to be comprised in a respective logical connection, and
map the logical connection into a broadcast/multicast radio channel which corresponds to the operable connection between a terminal means operated to receive the multicast stream and its respective base station means.

17. A computer program product having computer readable instructions stored thereon, the instructions including
sending a multicast stream over a dedicated logical connection between a stream source of the multicast stream and selected ones of a plurality of base stations which are selected to be comprised in a respective logical connection, and
mapping the logical connection into a broadcast/multicast radio channel which corresponds to an operable connection between a terminal operated to receive the multicast stream and a respective base station.
